(19) United States
(12) Patent Application Publication
(10) Pub. No.: US 2017/0142376 A1
(43) Pub. Date: May 18, 2017

(54) MOBILE SECURITY CAMERA SYSTEM

(71) Applicant: Rebecca Zeller, Yuma, AZ (US)

(72) Inventor: Rebecca Zeller, Yuma, AZ (US)

(21) Appl. No.: 14/940,912

(22) Filed: Nov. 13, 2015

(51) Int. Cl. H04N 7/18; H04N 1/00; H04M 1/725; H04N 5/225

(52) U.S. Cl. CPC H04N 7/185; H04N 5/2252; H04N 7/188; H04N 1/00307; H04M 1/72533; H04M 1/72527

(57) ABSTRACT

A mobile security camera system includes a housing having a front side, a rear side and a perimeter wall extending between the front and rear sides. A processor is mounted in the housing. A power source is mounted in the housing and is electrically coupled to the processor. A camera is mounted on the housing and is electrically coupled to the processor. A transceiver is mounted in the housing and is electrically coupled to the processor. The transceiver wirelessly transmits images captured by the camera utilizing a cellular phone service provider. A sensor is mounted to the housing and detects movement proximate to the housing. The sensor is electrically coupled to the processor. The processor actuates the camera to capture images when the sensor detects movement. A cellular phone sends and receives wireless communications with the transceiver. The cellular phone receives the images transmitted by the transceiver.

BACKGROUND OF THE DISCLOSURE

Field of the Disclosure

The disclosure relates to security camera devices and more particularly pertains to a new security camera device for capturing images of a person breaking into a vehicle.

### SUMMARY OF THE DISCLOSURE

An embodiment of the disclosure meets the needs presented above by generally comprising a housing having a front side, a rear side and a perimeter wall extending between the front and rear sides. A processor is mounted in the housing. A power source is mounted in the housing and is electrically coupled to the processor. A camera is mounted on the housing and is electrically coupled to the processor. A transceiver is mounted in the housing and is electrically coupled to the processor. The transceiver wirelessly transmits images captured by the camera utilizing a cellular phone service provider. A sensor is mounted to the housing and detects movement proximate to the housing. The sensor is electrically coupled to the processor. The processor actuates the camera to capture images when the sensor detects movement. A cellular phone sends and receives wireless communications with the transceiver. The cellular phone receives the images transmitted by the transceiver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective in-use view of a mobile security camera system according to an embodiment of the disclosure.

FIG. 2 is a front view of an embodiment of the disclosure.

FIG. 3 is a rear perspective view of an embodiment of the disclosure.

FIG. 4 is a top view of an embodiment of the disclosure.

FIG. 5 is a schematic view of an embodiment of the disclosure.

### DESCRIPTION OF THE PREFERRED EMBODIMENT

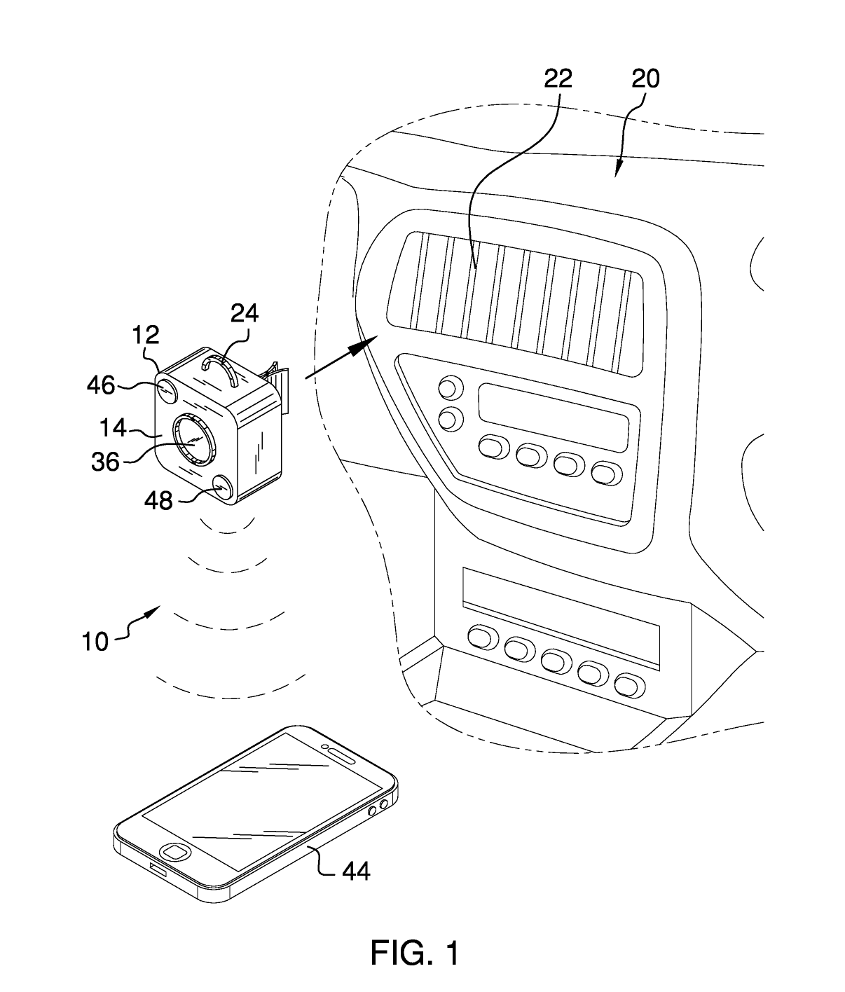

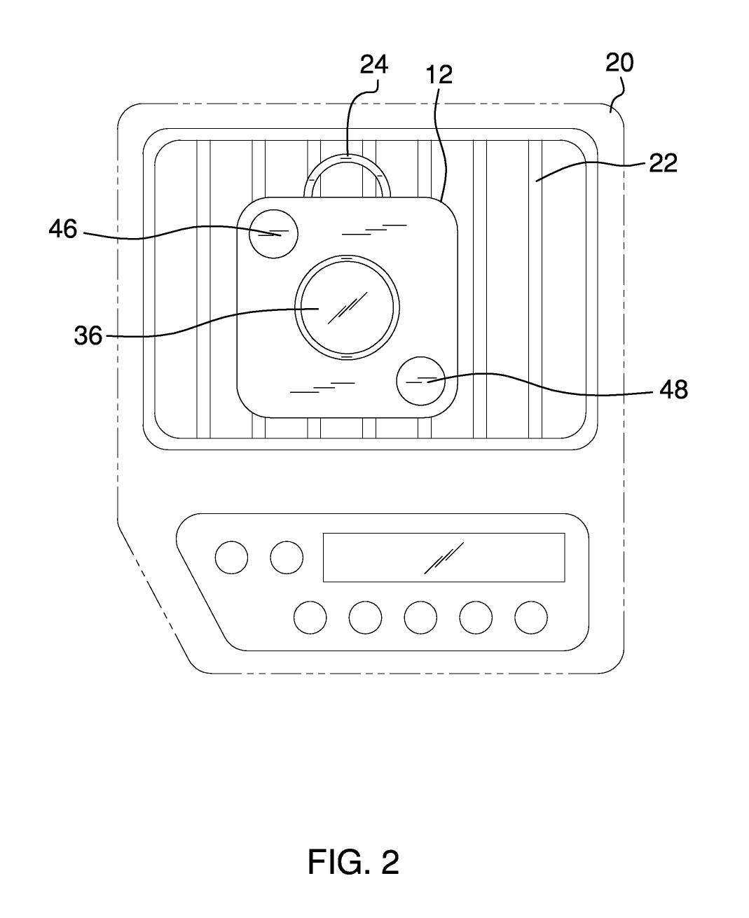

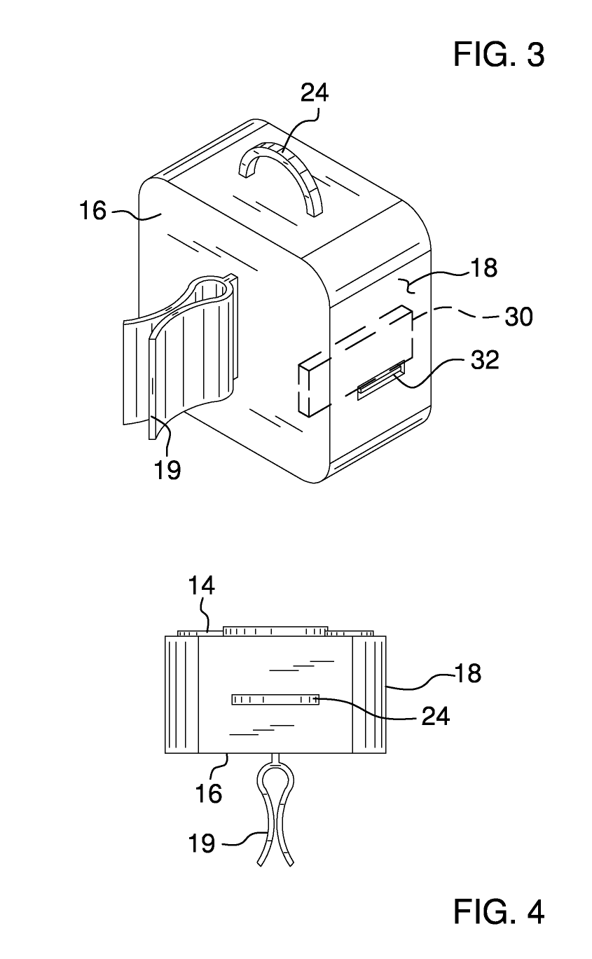

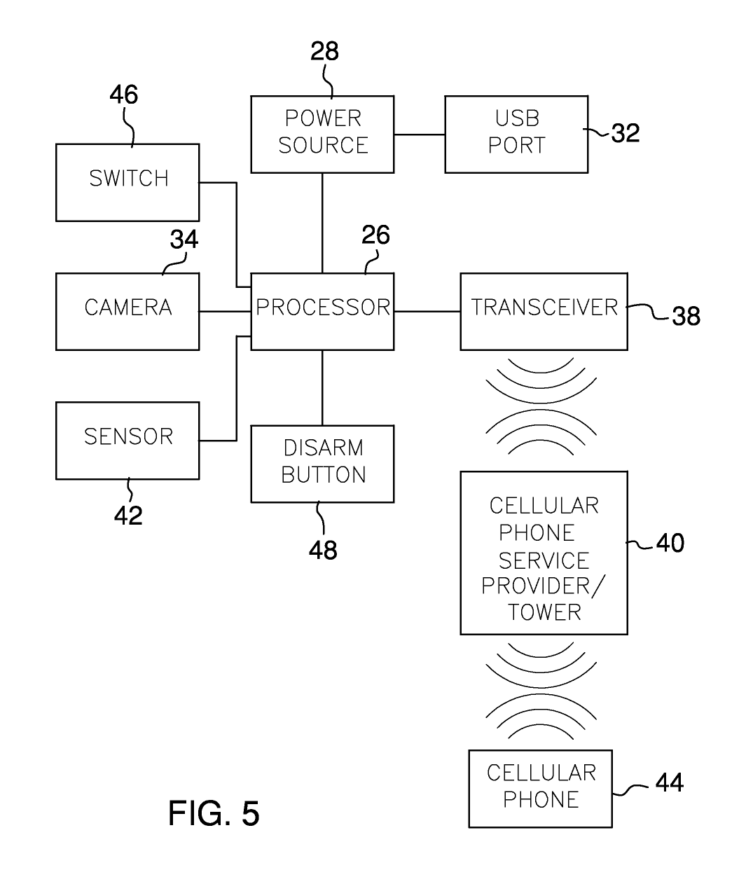

With reference now to the drawings, and in particular to FIGS. 1 through 5 thereof, a new security camera device embodying the principles and concepts of an embodiment of the disclosure and generally designated by the reference numeral 10 will be described.

As best illustrated in FIGS. 1 through 5, the mobile security camera system 10 generally comprises a housing 12 that has a front side 14, a rear side 16 and a perimeter wall 18 extending between the front 14 and rear 16 sides. While shown in a rectangular or square configuration, the housing 12 may have any suitable shape. The housing 12 has a length, width and height each being less than 3.0 inches to allow for easy portability of the housing 12. A coupler 19 is mounted on the housing 12 and is configured to releasably engage an object to releasably secure the housing 12 to the object. The coupler 19 may comprise a clip and in particular the coupler may be used for securing the housing 12 to an object found within a vehicle 20 such as the blades 22 of a vent such that the housing 12 is positioned to capture images of a person within the vehicle 20. A loop 24 may be attached to the housing 12 to facilitate transportation of the housing. Specifically, the loop 24 may be attached to a tether or a keychain.

Within the housing 12 is mounted a processor 26, or CPU, and a power source 28, which is also mounted in the housing 12, is electrically coupled to the processor 26. The power source 28 will typically comprise a battery 30 and may further comprise a rechargeable battery. However, a power cord, not shown, may be electrically coupled to the processor 26 and the power cord electrically engaged with an outlet within the vehicle 20 to provide power to the processor 26 and/or recharge the battery 30. Also, or alternatively, a USB port 32 may be mounted on the housing 12 and electrically coupled to the battery 30 for receiving a USB plug from a power cord to recharge the battery 30.

A camera 34 is mounted on the housing 12 and is electrically coupled to the processor 26. The camera 34 is a digital camera including a lens 36 facing outwardly from the front side of the housing. A transceiver 38 is mounted in the housing 12 and is electrically coupled to the processor 26. The transceiver 38 wirelessly transmits images captured by the camera 34. Preferably, the transceiver 38 is configured to communicate with a conventional cellular phone service provider 40 however other forms of wireless communication such as Bluetooth may be utilized as well.

A sensor 42 is mounted to the housing 12 and detects movement proximate to the housing 12. The sensor 42 is electrically coupled to the processor 26. The sensor 42, in particular, is configured to detect movement of a person though may be configured to detect vibrational movement as well. Thus, the sensor 42 may comprise an infrared radiation detector or a vibration detector or a combination of both. If the vehicle 20 is breached while the sensor 42 is being operated, the sensor 42 would detect the movement of the vehicle 20 or would detect the change in heat as a person moves within the vehicle 20. The processor 26 actuates the camera 34 to capture images when the sensor 42 detects movement and after the processor 26 receives an active signal. The processor 26 may be programmed to delay actuation of the camera 34 to capture images until after a predetermined amount of time has elapsed after the processor 26 receives the active signal. This predetermined amount of time may be between 30 seconds and 90 seconds.

A conventional cellular phone 44 is utilized to send and receive wireless communications with the transceiver 38. The cellular phone 44 receives the images transmitted by the transceiver 38 by way of the cellular phone service provider 40.

A switch 46 is mounted on the housing 12 and is electrically coupled to the processor 26. Actuation of the switch 46 sends the active signal to the processor 26. However, the cellular phone 44 may be configured, i.e. programmed with an application, to wirelessly send the active signal to the transceiver 38 such that the active signal sent by the cellular phone 44 is received by the processor 26. Additionally, the cellular phone 44 is configured to wirelessly send a disarm signal to the transceiver 38 such that the disarm signal sent by the cellular phone 44 is received by the processor 26. The processor 26 inhibits the camera 34 from capturing images when the disarm signal is received by the processor 26 Likewise, a disarm button 48 is mounted on the housing 12 and is electrically coupled to the processor 26. The disarm signal is sent to the processor 26 when the disarm button 48 is actuated. The disarm button 48 may also include the switch 46.

In use, the housing 12 is positioned where a person is concerned that a theft or other illegal activity may take place. Typically the housing 12 is placed within a vehicle 20 however, hotel rooms or other areas where the user may be concerned about theft may be considered as acceptable locales to utilize the system 10. The user turns on the sensor 42 by actuating the switch 46 or the cellular phone 44 to send the active signal to the processor 26. The processor 26 may delay the activation of the sensor 42, the capturing of images or the sending of images for a preselected amount of time to allow the user time to vacate the area in which the system 10 is being used. The user may use their cellular phone 44 to send the disarm signal, for instance, before they re-enter their vehicle 20 though the disarm button 48 may be used as well. Should the vehicle 20 be broken into while the sensor 42 is active, the camera 34 will capture images of the person in the vehicle 20 and send such to the cellular phone 44 so that the user may contact law enforcement and be aware that their vehicle is being burgled. The processor 26 may be programmed to cause the camera 34 to capture a series of images spaced from each other by between 1.0 second and 10.0 seconds.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A security camera system comprising:
a housing having a front side, a rear side and a perimeter wall extending between said front and rear sides;
a processor being mounted in said housing;
a power source being mounted in said housing and being electrically coupled to said processor;
a camera being mounted on said housing and being electrically coupled to said processor, said camera being a digital camera;
a transceiver being mounted in said housing and being electrically coupled to said processor, said transceiver wirelessly transmitting images captured by said camera, said transceiver being configured to communicate with a cellular phone service provider;
a sensor being mounted to said housing and detecting movement proximate to said housing, said sensor being electrically coupled to said processor;
said processor actuating said camera to capture images when said sensor detects movement; and
a cellular phone sending and receiving wireless communications with said transceiver, said cellular phone receiving said images transmitted by said transceiver.

2. The security camera system according to claim 1, wherein said housing has a length, width and height each being less than 3.0 inches.

3. The security camera system according to claim 1, wherein said processor actuating said camera to capture images when said sensor detects movement and after said processor receives an active signal.

4. The security camera system according to claim 3, further including a switch being mounted on said housing and being electrically coupled to said processor, wherein actuation of said switch sends said active signal to said processor.

5. The security camera system according to claim 4, wherein said processor delays actuation of said camera to capture images until after a predetermined amount of time has elapsed after said processor receives said active signal.

6. The security camera system according to claim 3, wherein said cellular phone is configured to wirelessly send said active signal to said transceiver such that said active signal sent by said cellular phone is received by said processor.

7. The security camera system according to claim 6, wherein said processor delays actuation of said camera to capture images until after a predetermined amount of time has elapsed after said processor receives said active signal.

8. The security camera system according to claim 6, wherein said cellular phone is configured to wirelessly send a disarm signal to said transceiver such that said disarm signal sent by said cellular phone is received by said processor, said processor inhibiting said camera from capturing images when said disarm signal is received by said processor.

9. The security camera system according to claim 4, further including a disarm button being mounted on said housing and being electrically coupled to said processor, a disarm signal being sent to said processor when said disarm button is actuated, said processor inhibiting said camera from capturing images when said disarm signal is received by said processor.

10. The security camera system according to claim 1, further including a coupler being mounted on said housing, said coupler being configured to releasably engage an object to releasably secure said housing to the object.

11. The security camera system according to claim 10, further including a loop being attached to said housing to facilitate transportation of said housing.

12. The security camera system according to claim 11, further including:
wherein said processor actuates said camera to capture images when said sensor detects movement and after said processor receives an active signal;
a switch being mounted on said housing and being electrically coupled to said processor, wherein actuation of said switch sends said active signal to said processor;
said cellular phone being configured to wirelessly send said active signal to said transceiver such that said active signal sent by said cellular phone is received by said processor;
said cellular phone being configured to wirelessly send a disarm signal to said transceiver such that said disarm signal sent by said cellular phone is received by said processor, said processor inhibiting said camera from capturing images when said disarm signal is received by said processor; and
a disarm button being mounted on said housing and being electrically coupled to said processor, said disarm signal being sent to said processor when said disarm button is actuated.

13. The security camera system according to claim 1, further including a loop being attached to said housing to facilitate transportation of said housing.

14. A security camera system comprising:
a housing having a front side, a rear side and a perimeter wall extending between said front and rear sides, said housing having a length, width and height each being less than 3.0 inches;
a processor being mounted in said housing;
a power source being mounted in said housing and being electrically coupled to said processor;
a camera being mounted on said housing and being electrically coupled to said processor, said camera being a digital camera;
a transceiver being mounted in said housing and being electrically coupled to said processor, said transceiver wirelessly transmitting images captured by said camera, said transceiver being configured to communicate with a cellular phone service provider;
a sensor being mounted to said housing and detecting movement proximate to said housing, said sensor being electrically coupled to said processor;
said processor actuating said camera to capture images when said sensor detects movement and after said processor receives an active signal, said processor delaying actuation of said camera to capture images until after a predetermined amount of time has elapsed after said processor receives said active signal;
a switch being mounted on said housing and being electrically coupled to said processor, wherein actuation of said switch sends said active signal to said processor;
a cellular phone sending and receiving wireless communications with said transceiver, said cellular phone receiving said images transmitted by said transceiver;
said cellular phone being configured to wirelessly send said active signal to said transceiver such that said active signal sent by said cellular phone is received by said processor;
said cellular phone being configured to wirelessly send a disarm signal to said transceiver such that said disarm signal sent by said cellular phone is received by said processor, said processor inhibiting said camera from capturing images when said disarm signal is received by said processor;
a disarm button being mounted on said housing and being electrically coupled to said processor, said disarm signal being sent to said processor when said disarm button is actuated;
a coupler being mounted on said housing, said coupler being configured to releasably engage an object to releasably secure said housing to the object; and
a loop being attached to said housing to facilitate transportation of said housing.
